(19) United States
(12) Patent Application Publication
(10) Pub. No.: US 2019/0278948 A1
(43) Pub. Date: Sep. 12, 2019

(54) METHOD AND APPARATUS FOR MANAGING IDENTIFICATION SYSTEM FOR PROTECTING AND MONITORING ELECTRICAL INSTALLATION

(71) Applicant: ELECTRONICS AND TELECOMMUNICATIONS RESEARCH INSTITUTE, Daejeon (KR)

(72) Inventors: Hyunjoo KANG, Daejeon (KR); Yoon Young AN, Sejong-si (KR); Sung Hei KIM, Daejeon (KR); Taehyoung SHIM, Seoul (KR); Sangjin JEONG, Daejeon (KR)

(21) Appl. No.: 16/165,479

(22) Filed: Oct. 19, 2018

(30) Foreign Application Priority Data
Mar. 12, 2018 (KR) 10-2018-0028615
Aug. 14, 2018 (KR) 10-2018-0094886

(51) Int. Cl. G06F 21/73

(52) U.S. Cl. CPC G06F 21/73

(57) ABSTRACT

A method and apparatus for managing an identification system for a sensor device used to protect and monitor an electrical installation. The method includes receiving an identifier allocation request for allocation of an identifier of a sensor device and allocating the identifier to the sensor device in response to the identifier allocation request, in which the identifier includes a customer number used to identify an installation unit at which the sensor device is positioned, a sensor device name used to identify a type of the sensor device, an electrical installation name used to identify a target electrical installation in an electrical facility to be sensed by the sensor device, and a classified space name indicating information on a space in the electrical facility in which the sensor device is positioned.

### CROSS-REFERENCE TO RELATED APPLICATION(S)

This application claims the priority benefit of Korean Patent Application No. 10-2018-0028615, filed on Mar. 12, 2018, and Korean Patent Application No. 10-2018-0094886, filed on Aug. 14, 2018, in the Korean Intellectual Property Office, the disclosures of which are incorporated herein by reference for all purposes.

### BACKGROUND

### 1. Field of the Invention

One or more example embodiments relate to a method and apparatus for establishing or organizing an identification system to identify devices required when introducing electrical installations in operation and sensor devices configured to protect and monitor the electrical installations, and for managing identifiers in the identification system.

### 2. Description of Related Art

The intellectualization of electrical equipment or installations, which is also referred to as a smart grid, encompasses managing transmission and distribution networks, energy efficiency, and equipment or installation resources. An electrical installation of a customer or receiving end is a set of devices that is legally and systemically protected under an electric utility act (which varies by country) and satisfies a standard for electrical safety and equipment protection. For example, a government-affiliated organization, a related agency, or the like conducts an electrical safety inspection and a complete overhaul on a periodic basis, for example, annually, biennially, and triennially. In addition, they conduct a permanent inspection on a high-voltage receiver or where a certain amount or more power is consumed by assigning an electrical safety supervisor there. Such efforts for electrical safety have been made based on manpower or human resources, and thus data of each electrical installation and environment may not be managed in a more detailed and careful manner.

In addition, since an electrical installation may be degraded in quality depending on an environment around the electrical installation in addition to a change in load, permanent state monitoring, management, and protection may be needed to reduce electrical accidents and enable more effective resource management including maintenance and repair, and replacement. A latest electrical installation to which information technology (IT) convergence is applied may indicate or display energy consumption and quality information through the installation itself, a relay, and the like. However, such an electrical installation is expensive and lacks a capability of managing data obtained from each of devices provided in the installation.

In the past, electric power or utility companies focused on how to produce electricity more effectively, increase the quality of electric power, and manage resources more effectively. However, in recent times, they may focus more on how to effectively operate and integrate micro-grids, electric vehicles, and the like using distributed power, and new and renewable energy, such as, for example, wind power and solar energy, encourage consumers to participate more, and improve safety services. Protecting and monitoring electrical installations are closely related to a safety issue. In other words, stable operation, environment protection, and creation of consumer participation services may become more important, than generation of electricity. Information on electrical installations and distributed electric power on a user side, for example, for private and general uses, affects transmission, transformation, and distribution of electric power, and thus information on protecting and monitoring electrical installations on the user side may need to be integrated. Thus, to exchange such information on the user side, an identification system may be needed, and an apparatus for managing identifiers in the identification system may also be needed.

### SUMMARY

An aspect provides technology for defining an identification system for electrical installations and sensor devices.

Another aspect provides technology for searching for and identifying a device based on an identifier according to an identification system and determining a purpose of use and a position of the device.

Still another aspect provides identifier management technology for installing, replacing, and removing electrical installations and sensor devices.

According to an aspect, there is provided a method of managing an identification system, the method including receiving an identifier allocation request for allocation of an identifier of a sensor device, and allocating the identifier to the sensor device in response to the identifier allocation request. The identifier may include a customer number used to identify an installation unit at which the sensor device is positioned, a sensor device name used to identify a type of the sensor device, an electrical installation name used to identify a target electrical installation in an electrical facility to be sensed by the sensor device, and a classified space name indicating information on a space in the electrical facility in which the sensor device is positioned.

In response to a movement or a replacement of the sensor device, the method may further include changing the identifier of the sensor device.

A notification of a change of the identifier may be transferred to the sensor device through a data collection device configured to collect sensor data from the sensor device.

The changing may include inputting, to a file system, information on the change of the identifier, transferring the information, and transferring the notification of the change of the identifier to the sensor device based on the information such that the sensor device requests the change of the identifier.

The sensor device name and the electrical installation name may be defined based on a same identification reference method.

The electrical installation name and the classified space name may be determined based on a range in the electrical facility to be sensed by the sensor device.

In response to a movement or a removal of the sensor device, the method may further include deleting the identifier of the sensor device.

The identifier may be recovered.

According to another aspect, there is provided an identifier management apparatus including a communication module configured to receive an identifier allocation request for allocation of an identifier of a sensor device, and a controller configured to allocate the identifier to the sensor device in response to the identifier allocation request. The identifier may include a customer number used to identify an installation unit at which the sensor device is positioned, a sensor device name used to identify a type of the sensor device, an electrical installation name used to identify a target electrical installation in an electrical facility to be sensed by the sensor device, and a classified space name indicating information on a space in the electrical facility in which the sensor device is positioned.

In response to a movement or a replacement of the sensor device, the controller may be configured to change the identifier of the sensor device.

A notification of a change of the identifier may be transferred to the sensor device through a data collection device configured to collect sensor data from the sensor device.

The sensor device name and the electrical installation name may be defined based on a same identification reference method.

The electrical installation name and the classified space name may be determined based on a range in the electrical facility to be sensed by the sensor device.

In response to a movement or a removal of the sensor device, the controller may be configured to delete the identifier of the sensor device.

The identifier may be recovered.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 illustrates an example of a target for an identification system according to an example embodiment;

FIG. 2 illustrates an example of a sensor device to which an identification system is to be applied according to an example embodiment;

FIG. 3 illustrates an example of an identifier management system according to an example embodiment;

FIGS. 4A and 4B illustrate examples of an identification system for identifiers according to an example embodiment;

FIG. 5 illustrates an example of an identifier allocating operation of an identifier management apparatus of FIG. 3;

FIG. 6 illustrates an example of an identifier changing operation of an identifier management apparatus of FIG. 3;

FIG. 7 illustrates an example of an identifier deleting operation of an identifier management apparatus of FIG. 3; FIG. 8 illustrates an example of a customer number included in an identifier according to an example embodiment;

FIG. 9 illustrates an example of a space classifying method and an example of a classified space name included in an identifier according to an example embodiment; and

FIG. 10 illustrates an example of an identifier operating method for electrical installations and sensor devices of FIG. 1.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly-used dictionaries, are to be interpreted as having a meaning that is consistent with their meaning in the context of the relevant art and the present disclosure and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

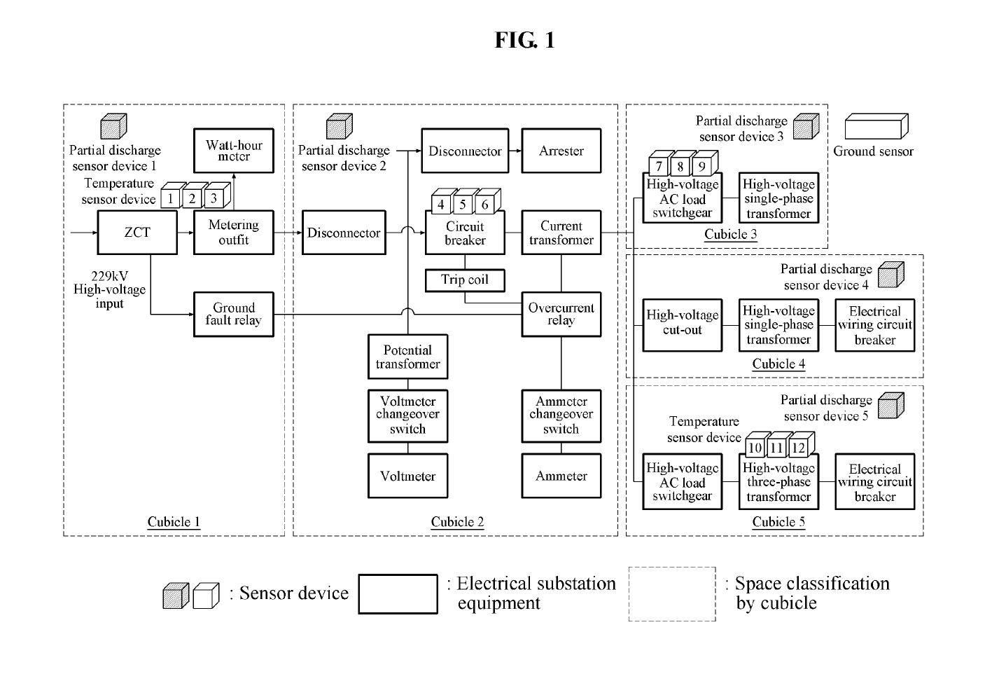

FIG. 1 illustrates an example of a target for an identification system according to an example embodiment.

Referring to FIG. 1, targets for an identification system include electrical installations and sensor devices in an electrical facility. The electrical facility described herein may be a private electrical facility including a private electrical installation, and an electrical installation described herein may be an individual electrical installation provided in the private electrical facility. For example, the private electrical facility may be an electrical facility that receives high-voltage electricity of 1 kilovolts (kV) or greater, and transforms and/or distributes the electricity in customer side.

The private electrical facility is classified into an outdoor electrical facility and an indoor electrical facility based on where it is disposed or installed. The indoor electrical facility may use cubicles to protect, for example, a transformer, a circuit breaker, an arrester, a current transformer, a high-voltage cutout switch, a potential or voltage transformer, a molded case circuit breaker (MCCB) or an electric wiring circuit breaker, and the like. The outdoor electrical facility is an electrical facility that is exposed to the outside.

FIG. 1 illustrates an example of a private electrical facility using five cubicles which divide sets of electrical substation equipment by dashed lines. The electrical substation equipment is interchangeably referred to as an electrical substation installation which also indicates a power receiving and transforming installation. In addition, the term “equipment” described herein is also interchangeably referred to as an installation. As illustrated in FIG. 1, in cubicle 1, a zero-phase-sequence current transformer (ZCT), a watt-hour meter, a metering outfit, and a ground fault relay are installed or disposed as electrical substation installations, and temperature sensor devices 1, 2, and 3 configured to measure temperatures of three phases of the metering outfit are also installed or disposed. In addition, partial discharge sensor device 1 is also installed to sense a partial discharge that may occur from the electrical substation installations disposed in cubicle 1.

A sensor device described herein refers to a device configured to transmit, to a remote data collection server, data sensed from an environment of a space in which an electrical installation is disposed or installed, or to support a function of protecting and monitoring an electrical installation through remote access. For example, a sensor device may be an electrical safety management system that is installed or used to protect and monitor an electrical installation. An identifier is allocated to a sensor device, and the data collection server may collect data from the sensor device using the identifier.

A target to be sensed by a sensor device is classified into three types. For example, a sensor device may sense a certain electrical installation. This type of sensor device may include temperature sensor devices 1 through 12 of a metering outfit, a circuit breaker, and a high-voltage alternating current (AC) load switchgear, and a high-voltage three-phase transformer which are electrical substation installations in the five cubicles as illustrated in FIG. 1. For another example, a sensor device may sense a space as a target. This type of sensor device may include partial discharge sensor devices 1 through 5 in the five cubicles as illustrated in FIG. 1. For still another example, a sensor device may sense an entire space of electrical installations, and this type of sensor device may include a ground sensor as illustrated in an uppermost right portion of FIG. 1.

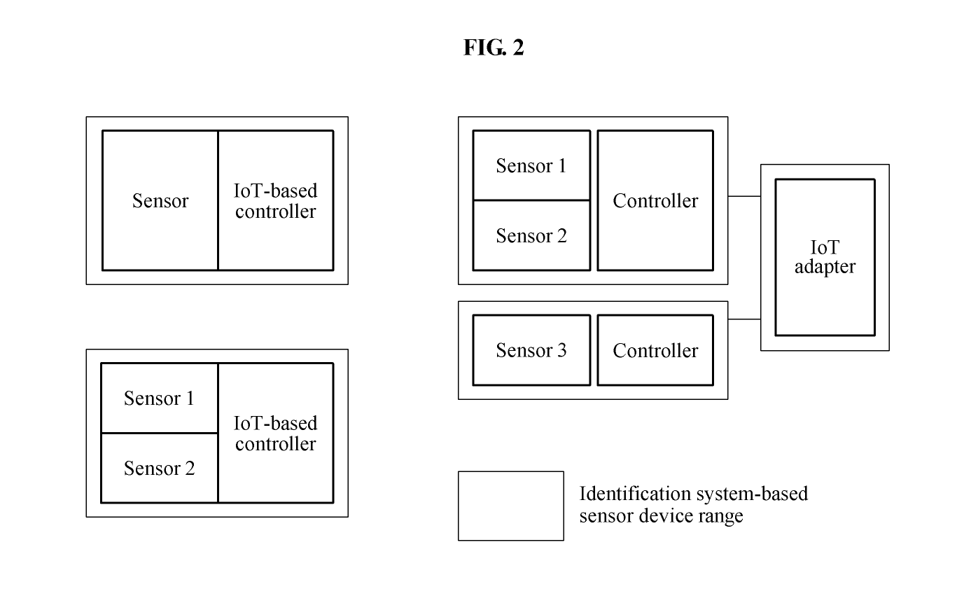

The electrical installations, and the sensor devices provided to protect and monitor the electrical installations in the electrical facility, which are illustrated in FIG. 1, may be targets for the identification system. FIG. 2 illustrates an example of a sensor device to which an identification system is to be applied according to an example embodiment.

Referring to FIG. 2, sensor devices are classified into a sensor device with an Internet of things (IoT) functionality and a sensor device without the IoT functionality. A sensor device includes a sensor and a controller, and an identifier is allocated to the sensor device based on the controller.

The IoT functionality may enable data exchange using an Internet protocol (IP)-based standard platform. An IoT adapter is configured to provide various interfaces such as serial communications and receive data from a sensor device without the IoT functionality and convert the received data to IP-based data. A sensor device is classified into three types of sensor device based on a physical area structure of a sensor and a controller.

A sensor device is embodied as a single physical device as illustrated in upper and lower left portions of FIG. 2, and a sensor device is also embodied as a plurality of physical devices as illustrated in a right portion of FIG. 2. As illustrated in the upper left portion of FIG. 2, a sensor device is provided as a single integral physical device in which a single sensor and a single controller are integrated. As illustrated in the lower left portion of FIG. 2, a sensor device is provided as a single integral physical device in which a plurality of sensors and a single controller are integrated. As illustrated in the right portion of FIG. 2, a sensor device includes a plurality of physically divided sensors, and a plurality of physically divided controllers which is connected to the plurality of sensors.

An identification system may be applied to sensor devices based on physical area structures as described above with reference to FIG. 2. An identifier may be allocated as illustrated in the following Table 1 based on the three structures illustrated in FIG. 2.

TABLE 1

| Number of | Number of | Number of |
|---|---|---|
| physical devices | sensors | identifiers allocated |
| 1 | 1 | 1 |
| 1 | multiple | 1 |
| 3 | multiple | 3 |

An identifier may be allocated to each of sensor devices that are physically classified. To a sensor device including a plurality of sensors, an identifier may be allocated to each of the sensors at a request from a user. In addition, a separate identifier may be allocated to the adapter.

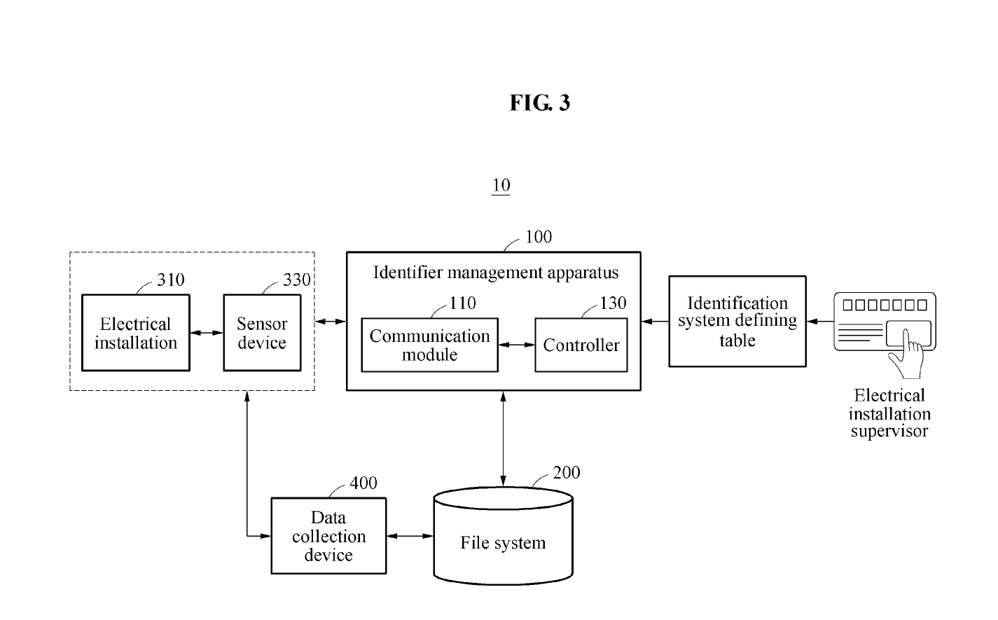

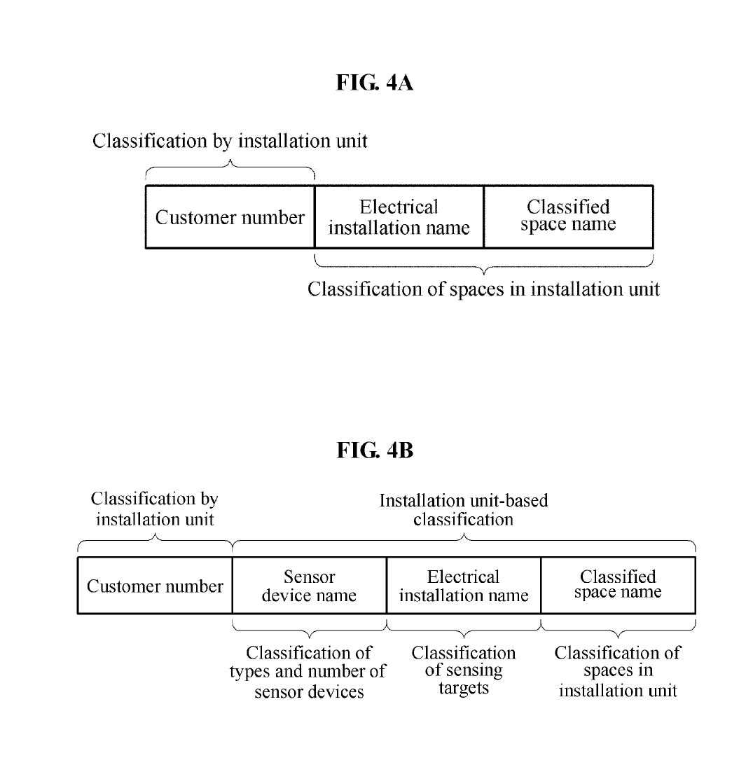

FIG. 3 illustrates an example of an identifier management system according to an example embodiment. FIG. 4A illustrates an example of an identification system for identifiers according to an example embodiment, and FIG. 4B illustrates another example of an identification system for identifiers according to an example embodiment.

Referring to FIG. 3, an identifier management system 10 includes an identifier management apparatus 100, a file system 200, an electrical installation 310, and a sensor device 330.

The identifier management apparatus 100 which is an identifier management server may perform an overall operation for identifying the electrical installation 310 and the sensor device 330. When the identifier management apparatus 100 verifies a change of the electrical installation 310 and the sensor device 330, the identifier management apparatus 100 reads identifier information from the file system 200 and determines validity of an identifier. In addition, the identifier management apparatus 100 allocates respective identifiers to the electrical installation 310 and the sensor device 330, and changes and deletes the identifiers.

An identification system for the electrical installation 310 and the sensor device 330 may be defined based on uniqueness of information, accessibility to data, expandability for a new service, and data processing efficiency. The identification system and an identifier management function satisfy the following requirements.

1) An identifier has a unique value.

2) An operation entity configured to allocate and manage an identifier is an identifier management apparatus.

3) An electrical installation and a sensor device use respective identifiers allocated by an identifier management apparatus.

4) An identification system is expandable to add, move, and delete an identifier of an electrical installation and/or a sensor device, in response to addition, movement, and deletion of the electrical installation and/or the sensor device.

5) An identifier is not dependent on a manufacturer or a producer, and a model.

6) An identifier includes space information.

7) An electrical installation and a sensor device include space information, and a new identifier is allocated thereto in response to a movement out of a defined space.

8) A new identifier is allocated in response to a change of a target installation to be sensed by a sensor device.

9) An allocated identifier is recovered or returned in response to a removal of an electrical installation and/or a sensor device.

The identifier management apparatus 100 includes a communication module 110 and a controller 130. The identifier management apparatus 100 communicates with the electrical installation 310, the sensor device 330, and/or the file system 200 through the communication module 110. The communication module 110 transmits and receives requests, and information or data. The controller 130 allocates respective identifiers to the electrical installation 310 and the sensor device 330 and manages the identifiers based on the requirements described in the foregoing to identify the electrical installation 310 and the sensor device 330.

In an environment where communication is available, but the identifier management apparatus 100 is not operable, identifiers may be allocated to the electrical installation 310 and the sensor device 330 using an identification system defining table for intercompatibility.

A data collection device 400 and the identifier management apparatus 100 may manage validity of identifiers through the file system 200 for common use and synchronize identifier information through a bilateral or interactive communication protocol in the absence of the common file system 200.

An identifier of an electrical installation may include a customer number, an electrical installation name, and a classified space name. FIG. 4A illustrates an example of such an identifier.

Customer number: is used to classify an electrical facility, or a private electrical facility, by a unit of owner, and indicate, for example, a customer name and address, a watt-hour meter number, a safety inspection customer number, and the like.

Electrical installation name: includes a term describing a function of a corresponding electrical installation, for example, a potential or voltage transformer, an electric wire, a circuit breaker, an arrester, and the like.

Classified space name: indicates space information on classified spaces in an electrical facility, for example, a cubicle number, a space or section name, and the like.

An identifier of a sensor device may include a customer number, a sensor device name, an electrical installation name, and a classified space name. FIG. 4B illustrates an example of such an identifier.

Customer number: is used to classify an electrical facility, or a private electrical facility, by a unit of owner, and indicate, for example, a customer name and address, a watt-hour meter number, a safety inspection customer number, and the like.

Sensor device name: indicates a type of sensor, and a sensor number or a number of sensors, for example, temperature, humidity, partial discharge, vibration, noise, and the like.

Electrical installation name: includes a term describing a function of an electrical installation and indicates a target to be sensed, for example, a potential or voltage transformer, an electric wire, a circuit breaker, an arrester, and the like.

Classified space name: indicates space information based on classified spaces in an electrical facility, for example, a cubicle number, a space or section name, and the like.

The customer number may be used to ensure uniqueness of an identifier and identify a unit of electrical facility. Herein, the electrical facility may refer to a facility installed to change a property or characteristic of electric power, for example, a property or characteristic of voltage and/or current, and may include, for example, a substation, a power-transmitting facility, and an electrical substation or a power-receiving substation.

A customer number used by an electric power company for electrical safety management may be used the customer number described in the foregoing. In the absence of an existing customer number, a customer number to be described later with reference to FIG. 8 may be used.

The electrical installation name may be used as an element of an identifier that allows a user to recognize an electrical installation corresponding to the identifier. In addition, when a sensor device senses environment information of an electrical installation, a target to be sensed by the sensor device may be recognized using an electrical installation name included in an identifier. For example, an abbreviated name may be used for an electrical installation name, for example, YPTR used as a power transformer, XCBR as a circuit breaker, TCTR as a current transformer, XSWI as a circuit switch, and ZBAT as a battery or an energy storage device. The sensor device name and the electrical installation name may be defined based on a same identification reference method. Table 2 indicates a representation example based on an identification reference method. In addition, a temperature sensor device may also use a recognizable name, for example, Temperature, Temp, TTMP, thermo-hygrometer, and the like. To use a sensor device name for an identifier, a unified notation system may be needed. For example, an abbreviated name may also be used as a sensor device name, for example, TTMP used as a temperature sensor and SPDC as a partial discharge sensor configured to monitor and diagnose partial discharge.

TABLE 2

| Identification | | Electrical | |
|---|---|---|---|
| reference | | installation | Classified |
| method | Sensor device name | name | space name |
| IEC61850 | LD Name/LN Name | LN Name | Refer to FIG. |
| Object | PD_sensor/Q0SPDC1 | Q0TCTR1 | 10 for space |
| Name | (logic node for | (logic node | classification |
| | monitoring partial | for current | values |
| | discharge) | transformer) | |
| URI | oic.r.partialdischarge | oic.r.MOF | |
| OID | a.b.c.d.e.f | a.b.c.d.e.x | |
| | (numerical | (numerical | |
| | sequence) | sequence) | |
| UUID | A(128-bit UUID) | X(128-bit UUID) | |
| User | PD1 | MOF | |
| defined | | | |

The classified space name may be used to identify position information on positions at which an electrical installation and a sensor device are disposed. Herein, space classification may be performed based on cubicle, function, sequence, and coordinates, and the like, and the classified space name may need to include such information. For example, to indicate a position of an indoor electrical substation installation using cubicles, the classified space name may be indicated as, for example, cubicle 1, cubicle 2, cubicle 3, and the like, as illustrated. In addition, a separate name may also be used for an entire space. For example, “ALL” may be used to indicate the entire space.

The electrical installation name and the classified space name may be determined based on a range sensed by a sensor device. For example, the electrical installation name and the classified space name may also be indicated in blank based on the range sensed by a sensor device.

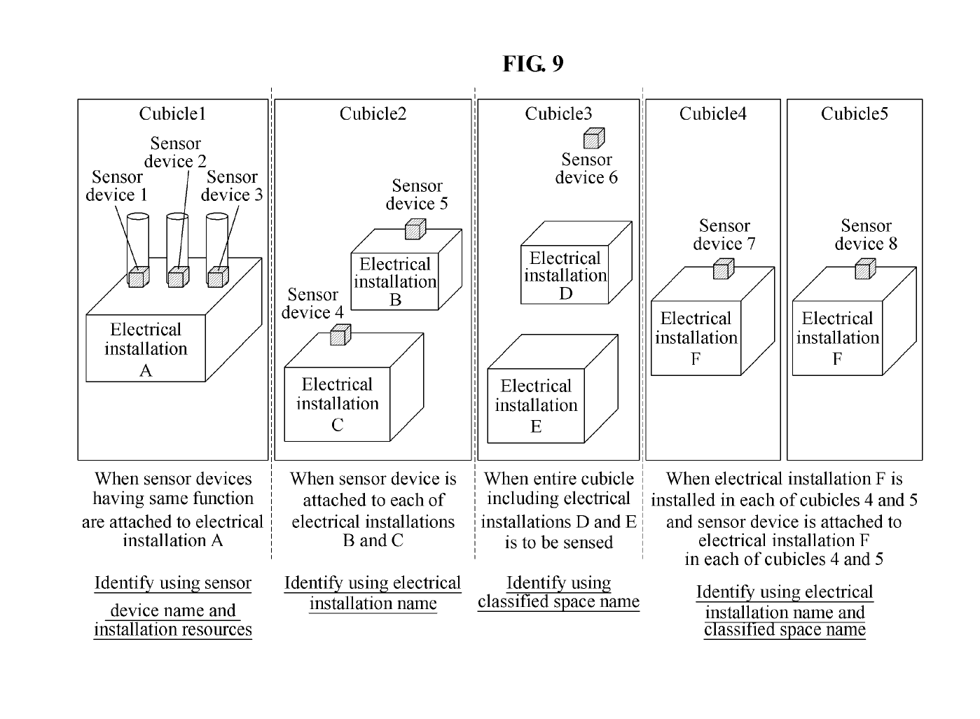

A sensor device may protect and monitor a target electrical installation in an electrical facility, and also an entire space of the electrical facility or a part of the entire space. Thus, a sensor device in an electrical installation may be identified by a classified space name based on a position defining a space. Hereinafter, how to classify a space and an example of the classified space will be described with reference to FIG. 9.

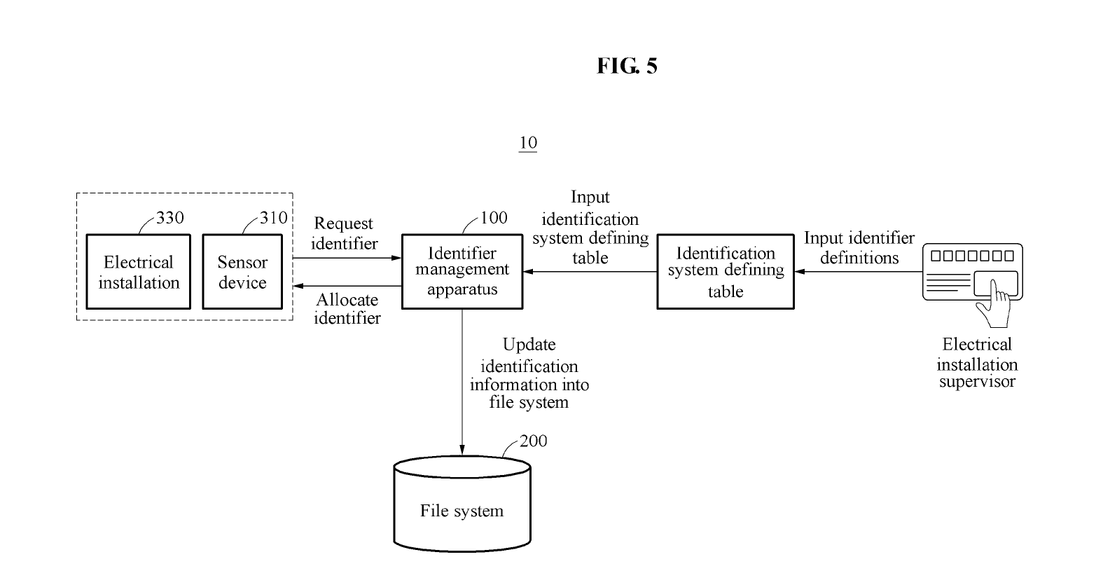

FIG. 5 illustrates an example of an identifier allocating operation of the identifier management apparatus 100 of FIG. 3.

Referring to FIG. 5, an electrical installation supervisor inputs an identifier definition, for example, an identification system defining table. That is, the identification system defining table is input to the identifier management apparatus 100 by the electrical installation supervisor. The identifier management apparatus 100 receives the identification system defining table and manages a list of identifiers. The identification system defining table is provided in various forms, for example, a file, a database, software, and the like.

The electrical installation 310 and the sensor device 330 transmit an identifier allocation request to the identifier management apparatus 100 to request the identifier management apparatus 100 to allocate identifiers. For example, in a case in which the electrical installation 310 and the sensor device 330 are initially turned on, or moved after being removed from original positions thereof, or have no identifiers, the electrical installation 310 and the sensor device 330 may request the identifier management apparatus 100 to allocate respective identifiers to the electrical installation 310 and the sensor device 330.

In response to the identifier allocation request, the identifier management apparatus 100 allocates, to the electrical installation 310 and the sensor device 330, identifiers generated based on the identification system defining table. The generated identifiers may satisfy the requirements described above.

The identifier management apparatus 100 allocates the new identifiers to the electrical installation 310 and the sensor device 330 and updates, into the file system 200, identification information of the electrical installation 310 and the sensor device 330, for example, identifier mapping information associated with mapping of the identifiers of the electrical installation 310 and the sensor device 330.

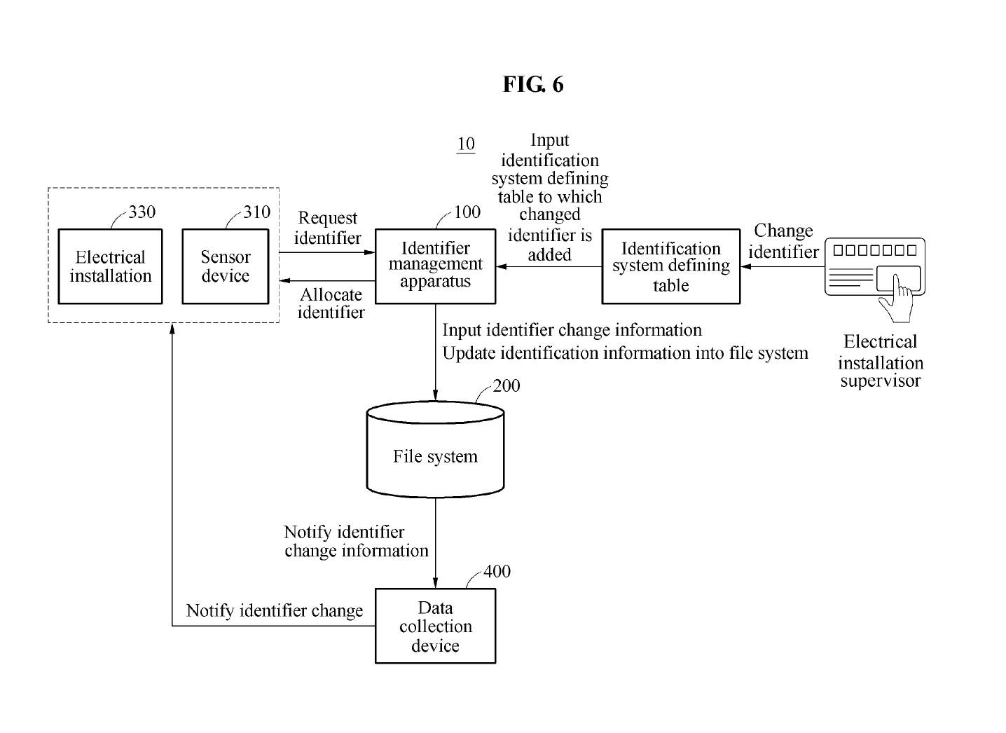

FIG. 6 illustrates an example of an identifier changing operation of the identifier management apparatus 100 of FIG. 3.

Referring to FIG. 6, although there is hardly a change in position of the electrical installation 310 once it is installed, such a change may occur in case of a movement of the electrical installation 310 due to a failure or breakdown, or a capacity expansion. An electrical installation supervisor notifies the identifier management apparatus 100 of an identifier change through an identification system defining table. The identifier management apparatus 100 performs an identifier changing operation based on the identification system defining table to which the identifier change is applied. That is, the identifier management apparatus 100 changes an identifier of the electrical installation 310 based on the identification system defining table to which the identifier change is applied.

In response to a change occurring when the electrical installation 310 and/or the sensor device 330 is moved or replaced, the identifier management apparatus 100 updates, into the file system 200, identifier change information of the electrical installation 310 and the sensor device 330.

The data collection device 400 verifies the identifier change information of the electrical installation 310 and the sensor device 330 from the file system 200 and transfers a notification of the identifier change to the electrical installation 310 and the sensor device 330. The data collection device 400 notifies the electrical installation 310 and the sensor device 330 of the identifier change such that the electrical installation 310 and the sensor device 330 request new or changed identifiers and receive newly allocated identifiers.

The electrical installation 310 and the sensor device 330 transmits an identifier allocation request to the identifier management apparatus 100 to request the identifier management apparatus 100 to allocate the new identifiers to the electrical installation 310 and the sensor device 330. In response to the identifier allocation request, the identifier management apparatus 100 allocates the new or changed identifiers to the electrical installation 310 and the sensor device 330 based on the identifier system defining table.

The identifier management apparatus 100 allocates the new or changed identifiers to the electrical installation 310 and the sensor device 330 and updates, into the file system 200, changed identification information of the electrical installation 310 and the sensor device 330, for example, changed identifier mapping information associated with mapping of the changed identifiers of the electrical installation 310 and the sensor device 330.

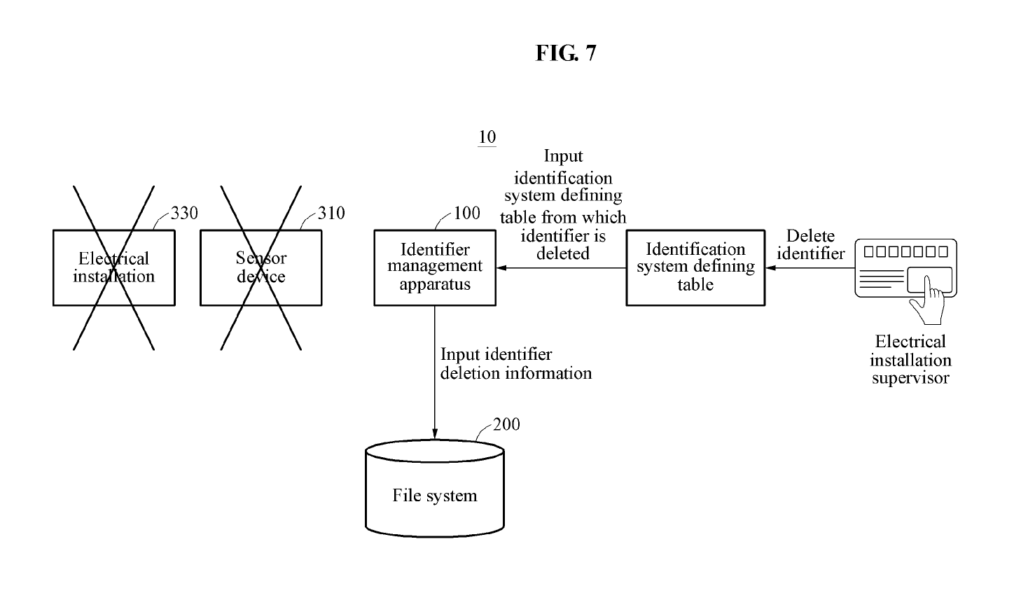

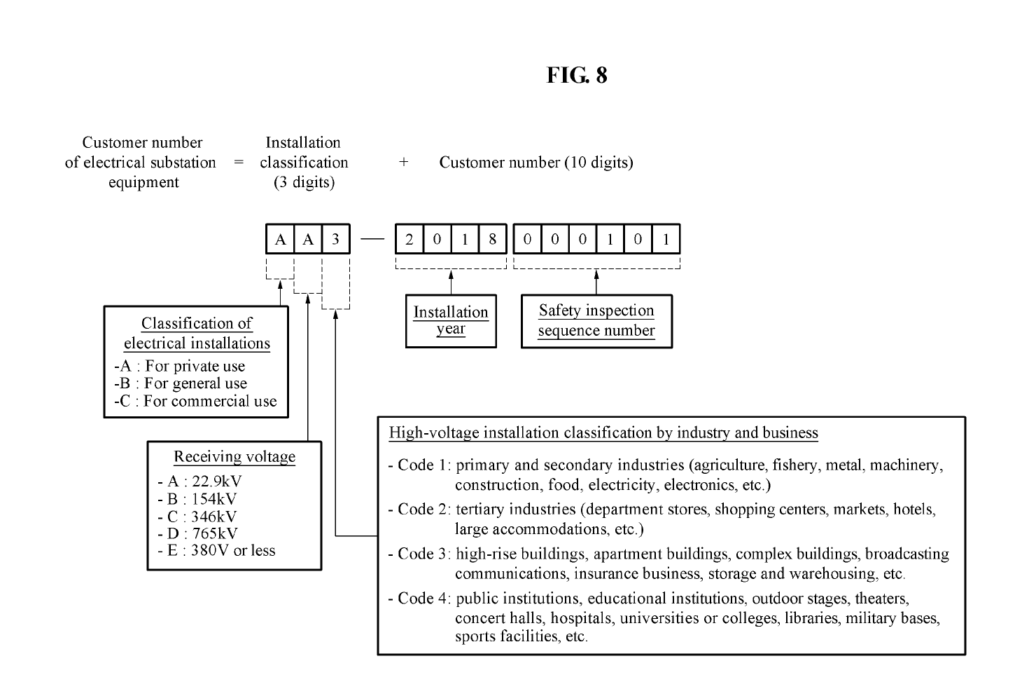

FIG. 7 illustrates an example of an identifier deleting operation of the identifier management apparatus 100 of FIG. 3.

Referring to FIG. 7, in a case in which the electrical installation 310 and/or the sensor device 330 is moved or removed, an electrical installation supervisor notifies the identifier management apparatus 100 of identifier deletion through an identification system defining table.

When the electrical installation 310 and/or the sensor device 330 is moved or removed, the identifier management apparatus 100 deletes existing identifiers that are previously allocated to the electrical installation 310 and the sensor device 330. In addition, the identifiers previously allocated to the electrical installation 310 and the sensor device 330 are recovered.

When the electrical installation 310 and/or the sensor device 330 is moved or removed, the identifier management apparatus 100 updates, into the file system 200, identifier deletion information of the electrical installation 310 and the sensor device 330. Herein, valid identifier information may be synchronized with the identification system defining table through the file system 200.

FIG. 8 illustrates an example of a customer number included in an identifier according to an example embodiment.

Referring to FIG. 8, a customer number is defined by a combination of an installation classification number and a customer classification number and used to indicate a classification state of an electrical installation.

Herein, electrical installations may be classified through major classification, medium classification, and minor classification. For example, the major classification is to classify electrical installations into categories, for example, (A) for private use, (b) for general use, and (c) for commercial use. For example, the medium classification is to classify electrical installations for private use into categories, for example, (A) with an extra-high voltage 22.9 kV, (B) 154 kV, (C) 346 kB, (D) 765 kV, and (E) 380 V or less. For example, the minor classification is to classify electrical installations with an extra-high voltage for private use into categories, for example, for use as a high-voltage installation.

In addition, electrical installations for use as a high-voltage installation may be classified into categories, for example, code 1 which is for use of primary and secondary industries including agriculture, fishery, metal, machine, construction, food, electricity, electronics, and the like; code 2 which is for use of tertiary industries including department stores, shopping centers, markets, hotels, large accommodations, and the like; code 3 for use at high-rise buildings, apartment buildings, complex buildings, and the like and for broadcasting communications, insurance business, storage, warehousing, and the like; and code 4 for use at public institutions, educational institutions, outdoor stages, theaters, concert halls, hospitals, universities or colleges, military bases, sports facilities, and the like.

The customer number may be about an owner of an electrical installation and be a 10-digit number of which front four digits indicate a year of its installation and rear six digits indicate a safety management sequence number. By using an existing customer number as the customer number, it is possible to facilitate data processing through interworking between new and old systems.

FIG. 9 illustrates an example of a space classifying method and an example of a classified space name included in an identifier according to an example embodiment.

Referring to FIG. 9, electrical installations and sensor devices are installed in various methods, and they are broadly classified into indoor ones and outdoor ones. The indoor electrical installations and sensor devices are also classified into a cubicle type and an open type. As illustrated in FIG. 9, a plurality of cubicles is installed, and a plurality of installations may be disposed in one cubicle. Hereinafter, how a sensor device is installed, and whether a target to be identified is a single electrical installation or multiple electrical installations in a space will be described.

1) Classification By Sensor Device Name

In a case in which a plurality of sensor devices having a same function is attached to an electrical installation A, an actual use of input data may not be identified only by a sensor device name. Thus, it may need to be identified by using a resource identifier of a sensor device and a resource of the electrical installation A.

2) Classification By an Electrical Installation Name

In a case in which a sensor device is attached to each of an electrical installation B and an electrical installation C in a same cubicle, for example, cubicle 2, information on each of the electrical installations B and C, along with a sensor resource name, may need to be included.

3) Classification By Space Name

In a case in which entire cubicle 3 including therein an electrical installation D and an electrical installation E is to be sensed, a sensor device may not be dependent on a certain electrical installation, but vary based on position information of a space which is cubicle 3. Thus, in such a case, information on space classification may be needed.

4) Classification By an Electrical Installation Name and a Space Name

In a case in which an electrical installation F is installed in a plurality of cubicles, for example, cubicle 4 and cubicle 5, and a sensor device is attached to the electrical installation F installed in each of cubicle 4 and cubicle 5, each sensor device has an identifier based on an electrical installation to which each sensor device is attached and on identification information of a cubicle in which each sensor device is included.

For example, in a case in which an electrical installation is installed in a cubicle and a sensor device protects and monitors an electrical installation in the cubicle, space classification may be performed using a cubicle number or a cubicle name. That is, a space may be classified into sections, for example, cubicles, and space information corresponding to each classified space may be assigned to an identifier. Thus, an operator or a service user may intuitively identify or recognize positions and related information based on the identifier. Table 3 indicates an example of space classification.

In a case of a space in which a cubicle is not installed, for example, as in some open-type electrical substation, the space may be classified by function, for example, a power measuring function, a circuit breaker protecting function, a measuring function for monitoring, a transforming function, a test function, and other functions, as indicated by “functionalName” in Table 3.

In addition, as indicated in Table 3, a sequence number (sequenceName) may be attached, and coordinates (coordinateName), a name as an indicator in a space (spaceName), a user-defined name of a section in a space (sectionName), and the like may also be set.

TABLE 3

| Space classification | Example of space classification | |
|---|---|---|
| enum | cubicleNumber[ ]; | sectionNumber[ ]; |
| sectionType{ | enum cubicleName { | enum sectionA |
| cubicles, | AISS, | { |
| functions, | MOF, | lead-in wire, |
| sequential, | ACB, | disconnector (or circuit switch), |
| coordinates, | PT, | power fuse, |
| space, | LA | arrester, |
| user-defined | TR, | metering outfit, |
| } | OCR, | relay, |
| | others, | switchgear |
| | } | } |
| | enum funtionalName { | enum sectionB |
| | Metering, | { |
| | Protecting, | circuit breaker, |
| | Measuring, | current relay, |
| | Transforming, | ground fault relay, |
| | Testing, | overcurrent relay |
| | others | } |
| | } | enum sectionC |
| | enum sequenceName { | { |
| | section1, | voltage transformer-side breaker, |
| | section2, | disconnector (or circuit switch) |
| | section3, | power fuse, |
| | section4, | } |
| | others | enum sectionD |
| | } | { |
| | enum codinateName { | single-phase transformer, |
| | GCS, | three-phase transformer, |
| | PCS, | disconnector (or circuit switch), |
| | others | condenser, |
| | } | MCCB |
| | enum spaceName (ex.){ | } |
| | gate, | enum sectionE |
| | emergency exit, | { |
| | east, west, south, north, | generator |
| | left, right, | } |
| | others | enum sectionF |
| | } | { |
| | | disconnector (or circuit switch) |
| | | battery |
| | | } |

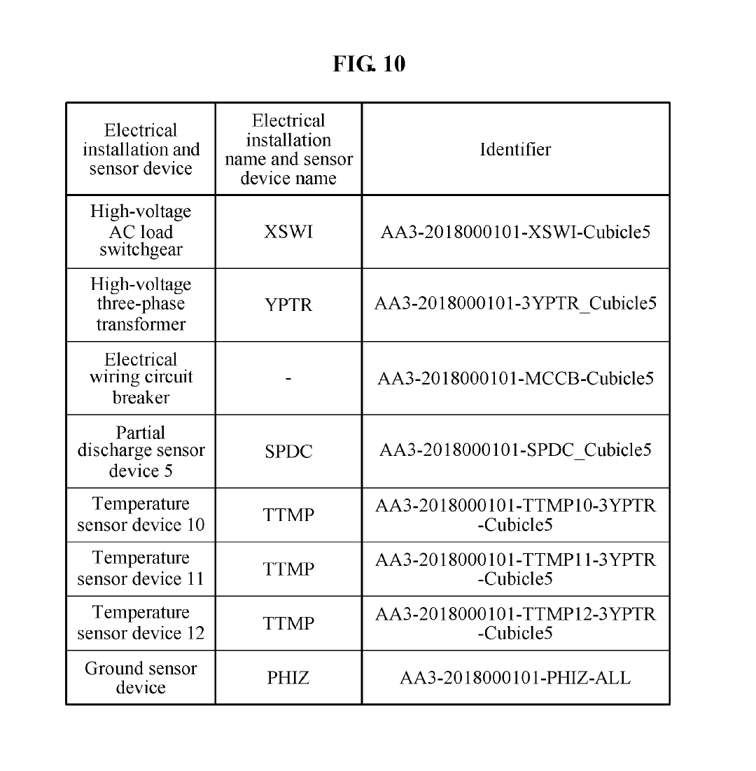

FIG. 10 illustrates an example of an identifier operating method for electrical installations and sensor devices of FIG. 1.

FIG. 10 illustrates an example of an identifier to be allocated to each of a high-voltage AC load switchgear, a high-voltage three-phase transformer, an MCCB or an electric wiring circuit breaker, temperatures sensor devices 10, 11, and 12, partial discharge sensor device 5, and a ground sensor device that are included in cubicle 5 illustrated in FIG. 1. Herein, an identifier may be allocated based on an identification system.

For convenience of description, the customer number described above with reference to FIG. 8 may be used for an identifier to be described with reference to FIG. 10. For example, when there is an available electrical installation with a receiving voltage of 22.9 kV that is installed in a complex building in a year, for example, 2018, and a safety management sequence number of the electrical installation is 101st, a customer number may be provided in a form of a 13-digit string, for example, “AA3-2018000101” as illustrated, including alphabet characters and numerals. In this example, a dash “-” in the middle of the string is used as a delimiter and may not be included in the customer number.

As a device abbreviated name, a logic node name of IEC 61850 is used. For example, an abbreviation of the high-voltage AC load switchgear may be XSWI which indicates a switching function. Thus, an identifier of the high-voltage AC load switchgear is “AA3-2018000101-XSWI-Cubicle5” to which the customer number, a name of an electrical substation installation, and a classified space name are applied.

Similarly, the high-voltage three-phase transformer has an identifier “AA3-2018000101-3YPTR_Cubicle5.” In this example, the prefix “three” or “3” is also added to an electrical installation name to indicate the three-phase transformer. Similarly, when there is a plurality of three-phase transformers, a suffix is also used to add a corresponding numeral or a classifying name.

For another example, when there is not an abbreviation for the electric wiring circuit breaker, an electrical term may be used as a name. Thus, the electric wiring circuit breaker is indicated as MCCB.

A target to be sensed by partial discharge sensor device 5 and a temperature sensor device is cubicle 5 and a high-voltage three-phase transformer, respectively. Thus, an identifier of partial discharge sensor device 5 configured to sense cubicle 5 as the target is “AA3-2018000101-SPDC_Cubicle5” as illustrated in FIG. 10. In addition, respective identifiers of temperature sensor devices 10, 11, and 12 are defined as “AA3-2018000101-TTMP10-3YPTR-Cubicle5,” “AA3-2018000101-TTMP11-3YPTR-Cubicle5,” and “AA3-2018000101-TTMP12-3YPTR-Cubicle5,” respectively.

The ground sensor device may sense all electrical installations in cubicles 1 through 5, and thus use a separate name, for example, ALL, because a classified space name corresponds to the entire space. Thus, an identifier of the ground sensor device is “AA3-2018000101-PHIZ-ALL.”

According to example embodiments described herein, by applying a new identification system to electrical installations and sensor devices, it is possible to verify purposes of use of the electrical installations and the sensor devices only using their identifiers. It is also possible to minimize an influence of a movement or a replacement of the electrical installations and/or the sensor devices on other systems or devices around them, in case of occurrence of such movement or replacement. In addition, it is also possible to verify position information on positions of the electrical installations and targets to be sensed by the sensor devices.

According to example embodiments described herein, it is possible to provide various identification systems based on IoT platforms and enable exchange of information with a service environment that is in operation, using an identification system defining table. In addition, through a connection or link with a visual application, it is possible to reduce computational complexity and reduce modifications of attribute information.

The components or units described in the example embodiments of the present disclosure may be achieved by hardware components including at least one of a digital signal processor (DSP), a processor, a controller, an application specific integrated circuit (ASIC), a programmable logic element such as a field programmable gate array (FPGA), other electronic devices, and combinations thereof. At least some of the functions or the processes described in the example embodiments of the present disclosure may be achieved by software, and the software may be recorded on a recording medium. The components, the functions, and the processes described in the example embodiments of the present disclosure may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of managing an identification system, the method comprising:
receiving an identifier allocation request for allocation of an identifier of a sensor device; and
allocating the identifier to the sensor device in response to the identifier allocation request,
wherein the identifier includes a customer number used to identify an installation unit at which the sensor device is positioned, a sensor device name used to identify a type of the sensor device, an electrical installation name used to identify a target electrical installation in an electrical facility to be sensed by the sensor device, and a classified space name indicating information on a space in the electrical facility in which the sensor device is positioned.

2. The method of claim 1, in response to a movement or a replacement of the sensor device, further comprising changing the identifier of the sensor device.

3. The method of claim 2, wherein a notification of a change of the identifier is transferred to the sensor device through a data collection device configured to collect sensor data from the sensor device.

4. The method of claim 2, wherein the changing comprises:
inputting, to a file system, information on a change of the identifier;
transferring the information; and
transferring a notification of the change of the identifier to the sensor device based on the information such that the sensor device requests the change of the identifier.

5. The method of claim 1, wherein the sensor device name and the electrical installation name are defined based on a same identification reference method.

6. The method of claim 1, wherein the electrical installation name and the classified space name are determined based on a range in the electrical facility to be sensed by the sensor device.

7. The method of claim 1, in response to a movement or a removal of the sensor device, further comprising deleting the identifier of the sensor device.

8. The method of claim 7, wherein the identifier is recovered.

9. An identifier management apparatus comprising:
a communication module configured to receive an identifier allocation request for allocation of an identifier of a sensor device; and
a controller configured to allocate the identifier to the sensor device in response to the identifier allocation request,
wherein the identifier includes a customer number used to identify an installation unit at which the sensor device is positioned, a sensor device name used to identify a type of the sensor device, an electrical installation name used to identify a target electrical installation in an electrical facility to be sensed by the sensor device, and a classified space name indicating information on a space in the electrical facility in which the sensor device is positioned.

10. The identifier management apparatus of claim 9, wherein, in response to a movement or a replacement of the sensor device, the controller is configured to change the identifier of the sensor device.

11. The identifier management apparatus of claim 10, wherein a notification of a change of the identifier is transferred to the sensor device through a data collection device configured to collect sensor data from the sensor device.

12. The identifier management apparatus of claim 9, wherein the sensor device name and the electrical installation name are defined based on a same identification reference method.

13. The identifier management apparatus of claim 9, wherein the electrical installation name and the classified space name are determined based on a range in the electrical facility to be sensed by the sensor device.

14. The identifier management apparatus of claim 9, wherein, in response to a movement or a removal of the sensor device, the controller is configured to delete the identifier of the sensor device.

15. The identifier management apparatus of claim 14, wherein the identifier is recovered.
